(19) United States
(12) Patent Application Publication
(10) Pub. No.: US 2023/0273046 A1
(43) Pub. Date: Aug. 31, 2023

(54) INFORMATION DISPLAY DEVICE AND RECORDING MEDIUM

(71) Applicants: TOYOTA JIDOSHA KABUSHIKI KAISHA, Toyota-shi (JP); DENSO CORPORATION, Kariya-shi (JP)

(72) Inventors: Takahiro MATSUNAGA, Mishima-shi (JP); Hiroki TERASHITA, Susono-shi (JP); Sui KURIHASHI, Sunto-gun (JP)

(73) Assignees: TOYOTA JIDOSHA KABUSHIKI KAISHA, Toyota-shi (JP); DENSO CORPORATION, Kariya-shi (JP)

(21) Appl. No.: 18/100,864

(22) Filed: Jan. 24, 2023

(30) Foreign Application Priority Data
Feb. 25, 2022 (JP) 2022-028134

(51) Int. Cl. G01C 21/36; G01C 21/34

(52) U.S. Cl. CPC G01C 21/3697; G01C 21/3469

(57) ABSTRACT

An information display device includes: a processor; and a display. Further, in a case where a travelable distance of a host vehicle when the host vehicle performs in-line travel is greater than the travelable distance of the host vehicle when the host vehicle does not perform the in-line travel by an increased amount of the travelable distance, the processor displays the increased amount of the travelable distance on the display.

### CROSS-REFERENCE TO RELATED APPLICATION(S)

The present application claims priority to and incorporates by reference the entire contents of Japanese Patent Application No. 2022-028134 filed in Japan on Feb. 25, 2022.

### BACKGROUND

The present disclosure relates to an information display device and a recording medium.

Japanese Laid-open Patent Publication No. 2014-054100 discloses a technique of calculating a travelable distance of a vehicle and displaying the calculated travelable distance on a display.

### SUMMARY

There is a need for providing an information display device and a recording medium capable of presenting advantages of in-line travel to a driver of a host vehicle.

According to an embodiment, an information display device includes: a processor; and a display. Further, in a case where a travelable distance of a host vehicle when the host vehicle performs in-line travel is greater than the travelable distance of the host vehicle when the host vehicle does not perform the in-line travel by an increased amount of the travelable distance, the processor displays the increased amount of the travelable distance on the display.

According to an embodiment, a non-transitory computer-readable recording medium stores an information display program causing a processor to display an amount of increase in a travelable distance on a display when the travelable distance of a host vehicle is increased by the host vehicle performing in-line travel as compared with the travelable distance of the host vehicle in a case where the host vehicle does not perform the in-line travel.

### BRIEF DESCRIPTION OF THE DRAWINGS

FIG. 1 is a block diagram illustrating a configuration of a vehicle that implements an information display device and an information display program according to an embodiment;

FIG. 2 illustrates one example of information displayed on a display by the information display device and the information display program according to the embodiment;

FIG. 3 is a flowchart illustrating a first example of a processing procedure of the information display method executed by the information display device according to the embodiment; and

FIG. 4 is a flowchart illustrating a second example of the processing procedure of the information display method executed by the information display device according to the embodiment.

### DETAILED DESCRIPTION

In the related art, there is a demand for a technique of presenting advantages of in-line travel to a driver of a host vehicle.

An information display device and an information display program according to an embodiment of the present disclosure will be described with reference to the drawings. Note that components in the embodiment below include those that can be easily replaced by those skilled in the art or those that are substantially the same.

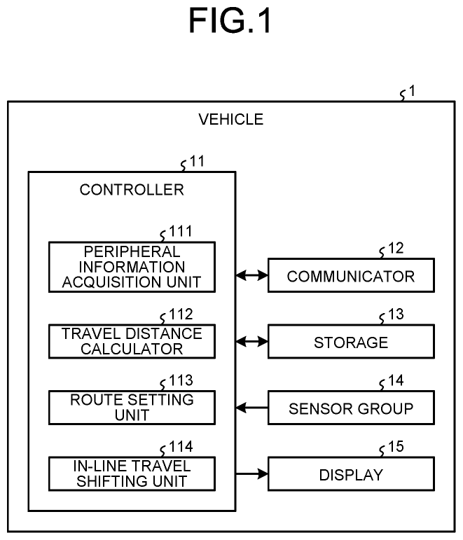

Information Display Device The information display device is used for displaying information related to in-line travel of vehicles. This information display device is implemented by a function of a vehicle 1 as illustrated in FIG. 1, for example. The “in-line travel” herein refers to vehicles travel following other preceding vehicles from the rear to achieve effects of reducing, for example, fuel consumption and electricity consumption.

Examples of the vehicle 1 include an engine vehicle, a hybrid electric vehicle (HEV), a plug-in hybrid electric vehicle (PHEV), a fuel cell electric vehicle (FCEV), and a battery electric vehicle (BEV). Furthermore, the vehicle 1 may be a manually driven vehicle or an automatically driven vehicle.

As illustrated in FIG. 1, the vehicle 1 includes a controller 11, a communicator 12, a storage 13, a sensor group 14, and a display 15.

Specifically, the controller 11 is an electronic control unit (ECU) including a microcomputer as a main component, and executes various programs. The microcomputer includes a central processing unit (CPU), a read only memory (ROM), and a random access memory (RAM). The controller 11 executes various programs to integrally control operations of various components mounted on the vehicle 1. Furthermore, the controller 11 functions as a peripheral information acquisition unit 111, a travel distance calculator 112, a route setting unit 113, and an in-line travel shifting unit 114 through execution of various programs.

The peripheral information acquisition unit 111 acquires information on the surroundings (hereinafter, referred to as “peripheral information”) of a host vehicle (vehicle 1). The peripheral information includes, for example, an image of a surrounding vehicle, position information on the surrounding vehicle, a speed (current speed) of the surrounding vehicle, a width of the surrounding vehicle, a distance between the surrounding vehicle and the host vehicle, and the presence or absence of traffic congestion on a route on which the host vehicle travels.

The peripheral information can be acquired by communication between the sensor group 14 and the communicator 12 of the vehicle 1, vehicle-to-vehicle communication, road-to-vehicle communication, or the like. Furthermore, the “width of the surrounding vehicle” of the peripheral information may be directly acquired by the above-described means, or may be obtained by analyzing an image of the surrounding vehicle acquired by the above-described means. Furthermore, the “distance between the surrounding vehicle and the host vehicle” of the peripheral information may be directly acquired by the above-described means, or may be calculated based on the position information on the surrounding vehicle acquired by the above-described means and the position information on the host vehicle acquired through the sensor group 14.

The travel distance calculator 112 calculates a travelable distance of the host vehicle. Specifically, the travel distance calculator 112 calculates an amount of the travelable distance of the host vehicle increased by performing in-line travel. Then, when the travelable distance of the host vehicle is increased by the host vehicle performing the in-line travel as compared with that in a case where the host vehicle does not perform the in-line travel, the travel distance calculator 112 displays the amount of increase in the travelable distance on the display 15.

Here, a situation in which the travel distance calculator 112 displays the amount of increase in the travelable distance on the display 15 can be divided into a case where the host vehicle has already performed the in-line travel and a case where the host vehicle has not performed the in-line travel yet. When calculating the amount of increase in the travelable distance, the travel distance calculator 112 first determines whether or not the host vehicle has performed the in-line travel based on the position information on the host vehicle acquired through the sensor group 14, and performs processing in accordance with the determination result. One example of processing performed by the travel distance calculator 112 in each situation will be described below.

Case where Host Vehicle is in In-Line Travel

When the host vehicle has already performed the in-line travel, the travel distance calculator 112 displays, on the display 15, an amount of the travelable distance increased by continuing the in-line travel on this way. Displaying the amount of the travelable distance increased by continuing the in-line travel in a visible manner as described above allows a driver to easily grasp advantages of the in-line travel.

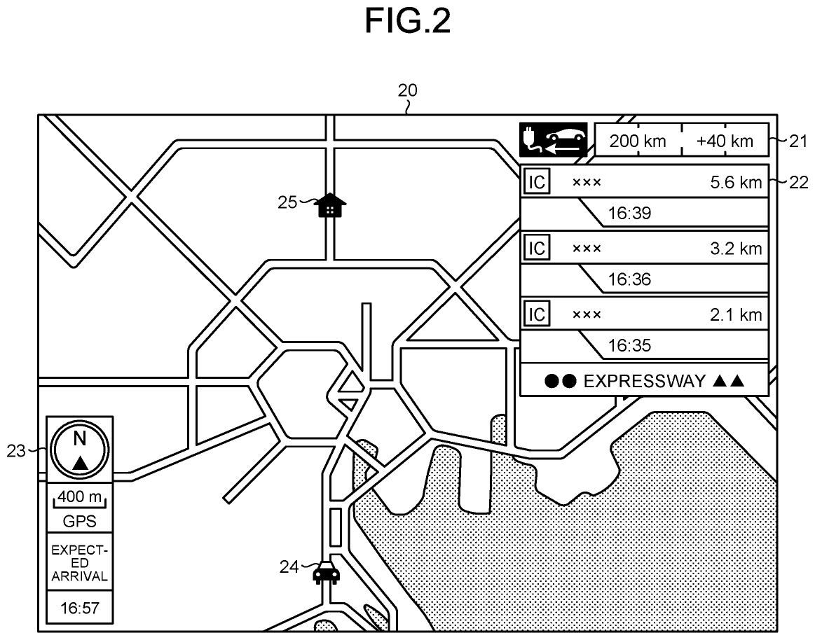

FIG. 2 illustrates one example of a route guide screen 20 displayed on the display 15. In addition to map information including a road (e.g., road used exclusively for automobile), the route guide screen 20 includes a region 21, a region 22, a region 23, a host vehicle mark 24, and a home mark 25. An amount of increase in the travelable distance is displayed on the region 21. The next exit and the like (e.g., interchange (IC)) are displayed on the region 22. A direction, a map scale, an expected arrival time, and the like are displayed on the region 23.

The travel distance calculator 112 displays the amount of increase in the travelable distance on the region 21 of the route guide screen 20 in FIG. 2. This figure illustrates, in one example, that, for example, the current travelable distance is “200 km” and the travelable distance is increased by “+40 km” by continuing the in-line travel on this way.

When the host vehicle has already performed the in-line travel, the travel distance calculator 112 can calculate the amount of increase in the travelable distance from past travel data by using at least one of, for example, a speed of the host vehicle, a width of a preceding vehicle, and a distance between the preceding vehicle and the host vehicle, which have been acquired as peripheral information.

The “past travel data” is travel data at the time when the host vehicle performed in-line travel in the past. The past travel data includes, for example, a route on which the host vehicle performed the in-line travel in the past, a travelable distance (travel distance) in each route, a speed of the host vehicle at the time when the in-line travel was performed in each route, a width of a preceding vehicle at the time when the in-line travel was performed in each route, and a distance between the preceding vehicle and the host vehicle at the time when the in-line travel was performed in each route. Furthermore, the storage 13 preliminarily stores the past travel data.

First, the travel distance calculator 112 calculates a travelable distance (first travelable distance) in the case where the in-line travel is not performed in the route based on remaining energy and the like (e.g., remaining fuel and remaining battery amount) of the host vehicle. Subsequently, the travel distance calculator 112 calculates the amount of the travelable distance increased by continuing the in-line travel by subtracting the first travelable distance from a travelable distance (second travelable distance) at the time when the in-line travel was performed in the same route. The second travelable distance is included in the past travel data.

Here, the travel distance calculator 112 may further add the presence or absence of a traffic congestion on a route on which the host vehicle travels acquired as peripheral information in addition to the above-described information, and calculate the amount of increase in the travelable distance. The amount of increase in the travelable distance can be calculated more accurately by adding the presence or absence of a traffic congestion on a route on which the host vehicle travels as described above.

Case where Host Vehicle is not in In-Line Travel

When the host vehicle has not performed the in-line travel yet, the travel distance calculator 112 displays, on the display 15, an amount of the travelable distance increased by performing the in-line travel (see FIG. 2). Displaying the amount of the travelable distance increased by shifting to the in-line travel in a visible manner as described above allows a driver to easily grasp the advantages of the in-line travel.

Furthermore, when the route setting unit 113 has set the route (planned travel route) from a departure point to a destination, the travel distance calculator 112 may display, on the display 15, the amount of the travelable distance increased by performing the in-line travel (see FIG. 2). Presenting the amount of increase in the travelable distance on the route guide screen 20 displayed on the display 15 as described above allows the driver who is receiving a route guide to easily grasp the advantages of the in-line travel.

When the host vehicle has not performed the in-line travel yet, the travel distance calculator 112 calculates the amount of increase in the travelable distance from the past travel data, for example. The past travel data includes, for example, a route at the time when the host vehicle performed the in-line travel in the past, a travelable distance (travel distance) in each route, and the like.

First, the travel distance calculator 112 calculates a travelable distance (first travelable distance) in the case where the in-line travel is not performed in the route based on remaining energy (remaining fuel and remaining battery amount) of the host vehicle, the distance of a route from the departure point to the destination, and the like. Subsequently, the travel distance calculator 112 calculates the amount of the travelable distance increased by performing the in-line travel by subtracting the first travelable distance from a travelable distance (second travelable distance) at the time when the in-line travel was performed in the same route. The second travelable distance is included in the past travel data.

Here, the travel distance calculator 112 may further add the presence or absence of a traffic congestion on a route on which the host vehicle travels acquired as peripheral information in addition to the above-described information, and calculate the amount of increase in the travelable distance. The amount of increase in the travelable distance can be calculated more accurately by adding the presence or absence of a traffic congestion on a route on which the host vehicle travels as described above.

The route setting unit 113 searches for a route from the departure point to the destination based on a route search request input by a user (e.g., driver) of the vehicle 1 through the display 15 (e.g., car navigation device), and sets a route (planned travel route) selected by the user. The route setting unit 113 displays information such as the set route and the expected arrival time of the route on the route guide screen 20 in FIG. 2.

The in-line travel shifting unit 114 makes a shift so that the host vehicle performs the in-line travel under a predetermined condition. The in-line travel shifting unit 114 first detects a vehicle that is a candidate of a destination to be followed at the time when the in-line travel is performed (hereinafter, referred to as “candidate vehicle”). The in-line travel shifting unit 114 detects a candidate vehicle that travels in front of the host vehicle by analyzing, for example, an image in front of the host vehicle and position information on a vehicle in front of the host vehicle included in the peripheral information. Then, when the candidate vehicle is detected, the in-line travel shifting unit 114 makes a shift so that the host vehicle performs the in-line travel. Note that, in a method of making a shift to the in-line travel, when the vehicle 1 is a manually driven vehicle, a message such as “please make a shift to in-line travel” can be displayed on the display 15. Furthermore, when the vehicle 1 is an automatically driven vehicle, automatic shift may be made so that the vehicle 1 performs the in-line travel.

The communicator 12 includes, for example, a data communication module (DCM). The communicator 12 is connected to a wired or wireless network, and communicates with an external server and the like, for example. The communicator 12 thereby acquires peripheral information and the like.

The storage 13 includes recording media such as an erasable programmable ROM (EPROM), a hard disk drive (HDD), and a removable medium. Examples of the removable medium include disc recording media such as a universal serial bus (USB) memory, a compact disc (CD), a digital versatile disc (DVD), and a Blu-ray (registered trademark) disc (BD). The storage 13 can store an operating system (OS), various programs, various tables, various databases, and the like.

The storage 13 stores, as necessary, the peripheral information acquired by, for example, the past travel data, the communication between the sensor group 14 and the communicator 12, the vehicle-to-vehicle communication, and the road-to-vehicle communication.

The sensor group 14 acquires the peripheral information. Examples of the sensor group 14 include a camera, a millimeter wave sensor, an infrared sensor, a laser sensor, and a 3D-LiDAR. Furthermore, the sensor group 14 may include a GPS sensor, an acceleration sensor, and a vehicle speed sensor. The GPS sensor detects the position of the host vehicle. The acceleration sensor detects acceleration. The vehicle speed sensor detects vehicle speed.

The display 15 outputs predetermined information to a user (e.g., driver) of the vehicle 1. The display 15 is provided at a position visually recognizable to the user in a vehicle interior. Furthermore, the display 15 is achieved by a car navigation device, a multi-information display, a head-up display, or the like.

Furthermore, the display 15 may be achieved by, for example, a personal digital assistant (e.g., smartphone and tablet terminal) carried by the user. Furthermore, the display 15 may have an input function such as a microphone and a touch panel, through which a user instruction can be input, in addition to an information output function.

The display 15 displays, for example, peripheral information, an amount of increase in a travelable distance, route information, and information on a candidate vehicle (e.g., information on image and position of candidate vehicle). The peripheral information is acquired by the peripheral information acquisition unit 111. The amount of increase in the travelable distance is calculated by the travel distance calculator 112. The route information is set by the route setting unit 113. The information on a candidate vehicle is detected by the in-line travel shifting unit 114.

### First Example of Information Display Method

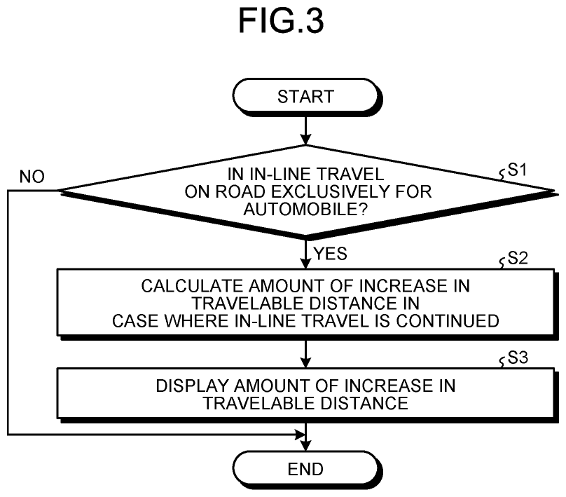

A first example of a processing procedure of an information display method executed by the information display device according to the embodiment will be described with reference to FIG. 3. Processing performed by the travel distance calculator 112 in a case where the host vehicle has already performed the in-line travel will be described below. Note that the processing described below is executed at a predetermined control cycle.

First, the travel distance calculator 112 determines whether or not the host vehicle is in the in-line travel on a road used exclusively for automobile (road exclusively for automobile) (Step S1). When determining that the host vehicle is in the in-line travel on the road exclusively for automobile (Yes in Step S1), the travel distance calculator 112 calculates an amount of increase in the travelable distance in a case where the in-line travel is continued on this way (Step S2). Subsequently, the travel distance calculator 112 displays the amount of increase in the travelable distance on, for example, the route guide screen 20 (see FIG. 2) displayed on the display 15 (Step S3), and completes the processing.

Note that, when determining that the host vehicle is not in the in-line travel on the road exclusively for automobile in Step S1 (No in Step S1), the travel distance calculator 112 completes the processing.

### Second Example of Information Display Method

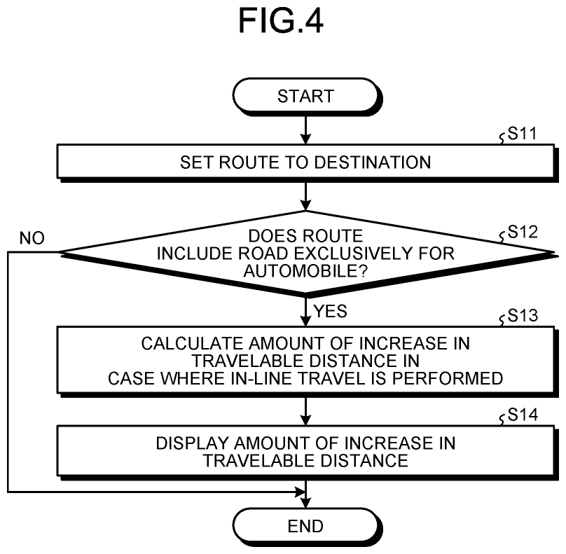

A second example of the processing procedure of the information display method executed by the information display device according to the embodiment will be described with reference to FIG. 4. Processing performed by the route setting unit 113 and the travel distance calculator 112 in a case where the host vehicle is not in the in-line travel yet will be described below. Note that the processing described below is executed at a predetermined control cycle.

First, the route setting unit 113 searches for and sets a route from a departure point to a destination (Step S11). Subsequently, the travel distance calculator 112 determines whether or not the route set in Step S11 includes a road exclusively for automobile (Step S12). When determining that the route includes the road exclusively for automobile (Yes in Step S12), the travel distance calculator 112 calculates the amount of increase in the travelable distance in the case where the in-line travel is performed (Step S13). Subsequently, the travel distance calculator 112 displays the amount of increase in the travelable distance on, for example, the route guide screen 20 (see FIG. 2) displayed on the display 15 (Step S14), and completes the processing.

Note that, when determining that the route does not include the road exclusively for automobile in Step S12 (No in Step S12), the travel distance calculator 112 completes the processing.

The information display device and the information display program according to the embodiment as described above can present the advantages of the in-line travel to the driver by displaying, on the display 15, an amount of the travelable distance increased by performing the in-line travel.

Additional effects and variations can be easily derived by those skilled in the art. Thus, the broader aspect of the present disclosure is not limited to the specific details and the representative embodiment represented and written above. Therefore, various modifications can be made without departing from the spirit or scope of the general inventive concept defined by the appended claims and equivalents thereof.

For example, although, in the embodiment, the description has been made on the assumption of a case where the function of the vehicle 1 achieves the information display device and the information display program, the information display device and the information display program may be achieved by another server that can communicate with the vehicle 1 over a network. In this case, the server can have the functions of the peripheral information acquisition unit 111, the travel distance calculator 112, the route setting unit 113, and the in-line travel shifting unit 114, and perform the information display method. This can reduce an arithmetic load on the side of the vehicle 1.

Furthermore, in the information display device and the information display program according to the embodiment, the travel distance calculator 112 calculates the amount of increase in the travelable distance from the past travel data by using the peripheral information (at least one of speed of host vehicle, width of preceding vehicle, and distance between preceding vehicle and host vehicle). In this case, artificial intelligence (AI) may be used. In this case, a prediction model (learned model) is constructed by machine learning using the peripheral information as an input parameter and using the amount of increase in the travelable distance as an output parameter. Then, in Step S2 in FIG. 3 and Step S13 in FIG. 4, the amount of increase in the travelable distance is calculated by using the prediction model. The amount of increase in the travelable distance can be calculated with higher accuracy by using AI as described above.

According to the present disclosure, advantages of in-line travel can be presented to a driver of a host vehicle.

According to an embodiment, it is possible to provide an advantages of in-line travel to a driver of the host vehicle.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information display device comprising: a processor; and a display,
wherein, in a case where a travelable distance of a host vehicle when the host vehicle performs in-line travel is greater than the travelable distance of the host vehicle when the host vehicle does not perform the in-line travel by an increased amount of the travelable distance, the processor displays the increased amount of the travelable distance on the display.

2. The information display device according to claim 1,
wherein, when the host vehicle is already in the in-line travel, the processor displays, on the display, the increased amount of the travelable distance which is obtained when the host vehicle continues the in-line travel.

3. The information display device according to claim 2,
wherein the processor calculates the increased amount of the travelable distance based on past travel data by using at least one of a speed of the host vehicle, a width of a preceding vehicle, and a distance between the preceding vehicle and the host vehicle.

4. The information display device according to claim 1,
wherein, when the host vehicle does not performs the in-line travel yet, the processor displays, on the display, the increased amount of the travelable distance which is obtained when the host vehicle performs the in-line travel.

5. The information display device according to claim 4,
wherein, when a route from a departure point to a destination of the host vehicle is set, the processor displays, on the display, the increased amount of the travelable distance which is obtained when the host vehicle performs the in-line travel.

6. The information display device according to claim 4,
wherein the processor calculates the increased amount of the travelable distance based on past travel data of the host vehicle.

7. The information display device according to claim 3,
wherein the processor calculates the increased amount of the travelable distance by further considering a presence or an absence of a traffic congestion on a route on which the host vehicle travels.

8. The information display device according to claim 6,
wherein the processor calculates the increased amount of the travelable distance by further considering a presence or an absence of a traffic congestion on a route on which the host vehicle travels.

9. A non-transitory computer-readable recording medium storing an information display program causing a processor to, in a case where a travelable distance of a host vehicle when the host vehicle performs in-line travel is greater than the travelable distance of the host vehicle when the host vehicle does not perform the in-line travel by an increased amount of the travelable distance, display the increased amount of the travelable distance on a display.

10. The non-transitory computer-readable recording medium according claim 9, wherein the information display program causes the processor to, when the host vehicle is already in the in-line travel, display the increased amount of the travelable distance which is obtained when the host vehicle continues the in-line travel on the display.

11. The non-transitory computer-readable recording medium according claim 10, wherein the information display program causes the processor to calculate the increased amount of the travelable distance based on past travel data by using at least one of a speed of the host vehicle, a width of a preceding vehicle, and a distance between the preceding vehicle and the host vehicle.

12. The non-transitory computer-readable recording medium according claim 9, wherein the information display program causes the processor to, when the host vehicle does not performs the in-line travel yet, display the increased amount of the travelable distance which is obtained when the host vehicle performs the in-line travel on the display.

13. The non-transitory computer-readable recording medium according claim 12, wherein the information display program causes the processor to, when a route from a departure point to a destination of the host vehicle is set, display the increased amount of the travelable distance which is obtained when the host vehicle performs the in-line travel on the display.

14. The non-transitory computer-readable recording medium according claim 12, wherein the information display program causes the processor to calculate the increased amount of the travelable distance based on past travel data of the host vehicle.

15. The non-transitory computer-readable recording medium according claim 11, wherein the information display program causes the processor to calculate the increased amount of the travelable distance by further considering a presence or an absence of a traffic congestion on a route on which the host vehicle travels.

16. The non-transitory computer-readable recording medium according claim 14, wherein the information display program causes the processor to calculate the increased amount of the travelable distance by further considering a presence or an absence of a traffic congestion on a route on which the host vehicle travels.
